(19) United States
(12) Patent Application Publication
(10) Pub. No.: US 2014/0015873 A1
(43) Pub. Date: Jan. 16, 2014

(54) ELECTRONIC DISPLAY DEVICE AND METHOD FOR CONTROLLING THE ELECTRONIC DISPLAY DEVICE

(71) Applicants: Taiki KASAI, Fukaya-shi (JP); Ichiro AKIYAMA, Fukaya-shi (JP); Keiichi INOUE, Fukaya-shi (JP); Takeshi DOI, Fukaya-shi (JP); Koki KIMURA, Fukaya-shi (JP); Katsuaki KUWASHIRO, Fukaya-shi (JP); Masaaki TAKUMA, Fukaya-shi (JP)

(72) Inventors: Taiki KASAI, Fukaya-shi (JP); Ichiro AKIYAMA, Fukaya-shi (JP); Keiichi INOUE, Fukaya-shi (JP); Takeshi DOI, Fukaya-shi (JP); Koki KIMURA, Fukaya-shi (JP); Katsuaki KUWASHIRO, Fukaya-shi (JP); Masaaki TAKUMA, Fukaya-shi (JP)

(21) Appl. No.: 13/790,990

(22) Filed: Mar. 8, 2013

(30) Foreign Application Priority Data
Jul. 13, 2012 (JP) 2012-157869

(51) Int. Cl. G09G 3/36

(52) U.S. Cl. CPC G09G 3/36
USPC 345/698; 345/87

(57) ABSTRACT

According to one embodiment, there is provided a second block that is connectable via an interface cable to a first block serving as a signal source, and supplies a high-resolution display with image data of a high resolution. The second block has an information transmitter for transmitting particular resolution information different from the high resolution when the resolution information of the high-resolution display is transmitted to the first block. The second block also has an image decoder for decoding, into image data of the high resolution, the image data processed based on the particular resolution information and sent from the first block. The decoded high-resolution image data is output to the high-resolution display.

### CROSS-REFERENCE TO RELATED APPLICATIONS

This application is based upon and claims the benefit of priority from Japanese Patent Application No. 2012-157869, filed Jul. 13, 2012, the entire contents of which are incorporated herein by reference.

### FIELD

Embodiments described herein relate generally to an electronic display device and a method for controlling the electronic display device.

### BACKGROUND

DVI-LVDS (digital visual interface-low voltage differential signal) conversion circuits, for example, have been developed as means for connecting a personal computer to a liquid crystal panel. The DVI-LDVS conversion circuits are used to supply signals to a liquid crystal panel that is made to have a two-layered liquid crystal display in order to enhance its contrast ratio, for example.

When a personal computer is connected to a liquid crystal panel, one DVI cable is lead from the computer and connected to a DVI-LVDS conversion circuit, from which two LVDS cables are lead and connected to the two layers of the liquid crystal display.

Meanwhile, high-resolution displays having pixels of, for example, 3840×2400 (so-called 4K2K) have come to be available. When high-resolution image data is retrieved from an image data source (e.g., a personal computer) and input to the high-resolution displays, two dual-link DVI cables are used at present.

The reason why two dual-link DVI cables are used will now be described. The one dual-link DVI cable can transmit a signal with a maximum output resolution at 60 Hz of 1920×2400 pixels (also called resolution of 1920×2400 pixels), and data-transmission capacity is insufficient to transmit a signal of 3840×2400 pixels (also called a signal with resolution of 3840×2400 pixels) by the one dual-link DVI cable, so two dual-link DVI cables are needed. If such a connection using two dual-link DVI cables is established between a high-resolution display and an image data source, a synchronization processor for synchronization of two signals is required, which makes the hardware structure complex. It is also considered to connect two dual-link DVI cables to two independent displays, respectively, thereby displaying images of 3840×2400 pixels in total on the two displays. In this case, however, a rendering program for the two displays is required.

There is a demand for further simplification of a connection between a high-resolution display of 4K2K and a high-resolution image data source.

### BRIEF DESCRIPTION OF THE DRAWINGS

FIG. 1 is an exemplary block diagram illustrating a basic structure employed in common between embodiments;

FIG. 2 is an exemplary block diagram illustrating an embodiment;

FIG. 3 is a flowchart useful in explaining an operation example of the embodiment shown in FIG. 2; and

FIG. 4 is an exemplary block diagram illustrating another embodiment.

### DETAILED DESCRIPTION

In general, according to one embodiment, there are provided an electronic display device and a control method for use in the electronic display device. In the electronic display device and its control method, an image data source and a high-resolution display can be connected by a single cable.

In one embodiment, there is provided a second block that is connectable via an interface cable to a first block serving as a signal source, and supplies a high-resolution display with image data of a high resolution. The second block has an information transmitter for transmitting particular display guidance information including resolution information indicating a low resolution different from the high resolution, when the resolution information of the high-resolution display is transmitted to the first block. Based on the particular display guidance information, the first block processes image data, to be transmitted, so that the image data becomes suitable to the transmission format or transmission capacity of the cable, and transmits the resultant image data to the second block. The second block also has an image decoder for decoding, into image data of the high resolution, the image data sent from the first block, based on the particular display guidance information. The decoded high-resolution image data is output to the high-resolution display.

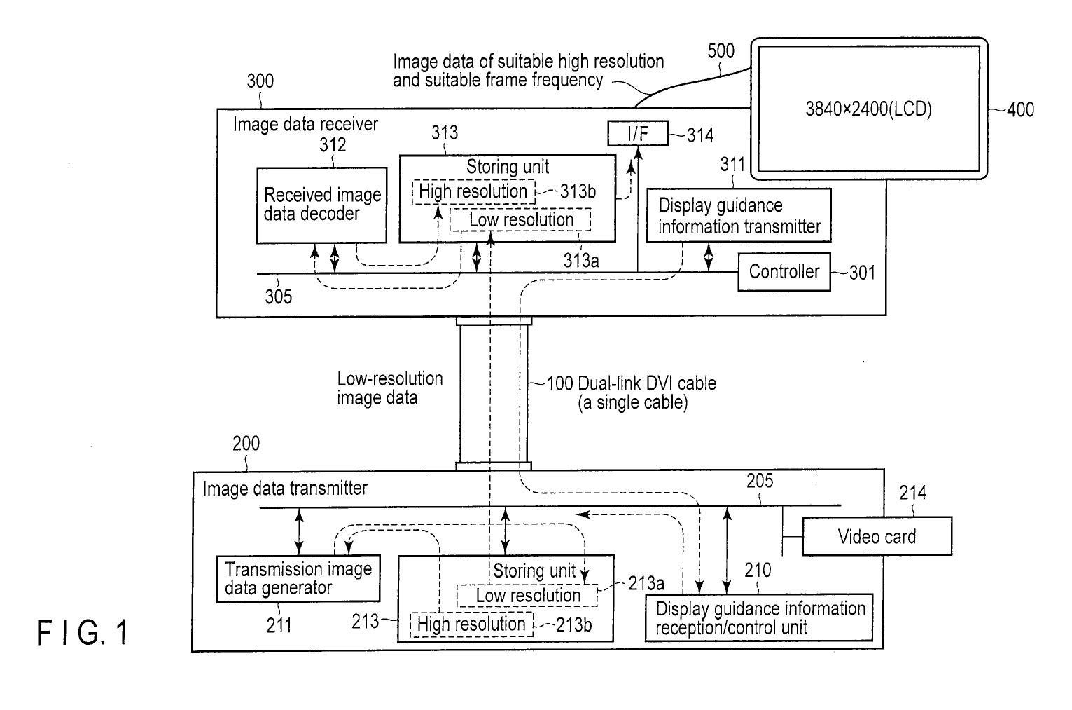

Embodiments will further be described with reference to the drawings. FIG. 1 is a block diagram illustrating a basic structure employed in common between the embodiments. As shown, an image data transmitter 200 is connected to an image data receiver 300 via one dual link DVI cable 100, and the image data receiver 300 is connected to a display 400.

The image data transmitter 200 comprises a display guidance information reception/control unit 210, a transmission image data generator 211, and a storing unit 213, which are respectively connected to a main bus 205. The display guidance information may also be called profile information.

The storing unit 213 comprises a low-resolution buffer 213a corresponding to low-resolution image data of, for example, 1920×2400 pixels, and a high-resolution buffer 213b corresponding to high-resolution image data of, for example, 3840×2400 pixels. Accordingly, high-resolution image data (of, for example, so-called 4K2K) can be transferred from, for example, a video card 214 to the storing unit 213 via the main bus 205.

The image data receiver 300 comprises a controller 301, a display guidance information transmitter 311, a received image data decoder (this may also be referred to as a converter) 312, a storing unit 313, and an output unit 314 serving as an interface and connected to the display 400, which are respectively connected to a main bus 305.

Like the storing unit 213 of the image data transmitter 200, the storing unit 313 comprises a low-resolution buffer 313a corresponding to low-resolution image data of, for example, 1920×2400 pixels, and a high-resolution buffer 313b corresponding to high-resolution image data of, for example, 3840×2400 pixels.

The display 400 has a liquid crystal display panel and is a high-resolution display with 3840×2400 pixels (so-called 4K2K).

Here, it is defined as the high-resolution as high resolution more than resolution according to the data-transmission capacity of one dual-link DVI cable.

The image data transmitter 200 may also be referred to as a block, or an image data source formed of, for example, a personal computer, described later. Further, the display guidance information reception/control unit 210, the transmission image data generator 211 and the storing unit 213 may also be referred to, for example, a video driver, an image converter and a VRAM, respectively, as described later.

Similarly, the image data receiver 300 may also be referred to as a block, or a DVI-LVDS converter 300. Further, the display guidance information transmitter 311, the received image data decoder 312 and the storing unit 313 may also be referred to, for example, an extended display identification data (EDID) information transmitter 311, an image decoder 312 and a video RAM (VRAM) 313 as a memory, respectively, as described later.

The operation of the above apparatus will be described briefly. The image data transmitter 200 is connected to the image data receiver 300 via the on dual-link cable 100, and the image data receiver 300 is connected to the display 400 via a LVDS cable 500.

Firstly, at the image data receiver 300, the display guidance information transmitter 311 is connected to the display 400 via the LVDS cable under a control of the controller 301, in order to obtain specification information of the display 400. Then, the display guidance information transmitter 311 retrieves, from the display 400, the specification information of the display 400, such as resolution information and frame frequency, under the control of the controller 301, the specification information is previously stored in the display 400. If the specifications of the display 400 to be connected are beforehand known, a user may manually input them.

By the above-mentioned operation, the display guidance information transmitter 311 detects the specification information (display guidance information), such as a high resolution and a frame frequency suitable for the display 400.

Upon receiving an instruction to start display from, for example, an operation unit (not shown), the controller 301 controls the display guidance information transmitter 311 to transmit particular display guidance information to the image data transmitter 200.

It should be noted that the display guidance information transmitter 311 does not transmit display guidance information indicating the high resolution and frame frequency suitable for the display 400 in the state as those are, but transmits particular display guidance information suitable for the specifications of the one dual-link DVI cable 100 that connects the image data transmitter 200 to the image data receiver 300. For instance, particular display guidance information indicating that the maximum output resolution of the one dual-link DVI cable 100 can suit a signal of 1920×2400 pixels at 60 Hz is sent to the image data transmitter 200.

Thus, the display guidance information transmitter 311 transmits, to the image data transmitter 200, particular display guidance information that differs from standard display guidance information suitable for the inherent high-resolution of the display 400. In other words, the display guidance information transmitter 311 detects the specification information of the display 400 and the transmission capacity information of the one dual-link DVI cable 100, and sets display guidance information indicating a particular resolution differ from the specification of the display 400, based on the difference in resolution between them, then the display guidance information transmitter 311 transmits the display guidance information to the image data transmitter 200.

In this embodiment, particular display guidance information indicating a signal of 1920×2400 pixels (a low-resolution signal) falling within the transmission capacity (low resolution) of the dual-link DVI cable 100 is transmitted. The signal of 1920×2400 pixels is a low-resolution signal that is ½ of the high-resolution signal of 3840×2400 suitable for the display 400.

Supplying the display 400 with a signal having a resolution suitable for the display 400 means that image data of a resolution and/or frame frequency, at which the display 400 can exhibit its maximum display performance, is supplied to the display 400.

In the image data transmitter 200 receiving particular display guidance information, the particular display guidance information is transmitted to the display guidance information reception/control unit 210. The display guidance information reception/control unit 210 checks the resolution of image data read from the video card 214 and stored to the high-resolution buffer 213b of the storing unit 213. If the resolution of the image data stored in the storing unit 213 differs from the resolution (low resolution) indicated by the particular display guidance information, i.e., if the resolution of the image data is high, the display guidance information reception/control unit 210 operates as follows: The display guidance information reception/control unit 210 controls the transmission image data generator 211 to compress, with a compression rate of, for example, ½, the high-resolution image data stored in the high-resolution buffer 213b of the storing unit 213, to form low-resolution image data, and then to write this data to the low-resolution buffer 213a. The resultant low-resolution image data is read from the low-resolution buffer 213a of the storing unit 213, then transmitted to the image data receiver 300 via the one dual-link DVI cable 100 under a control of the display guidance information reception/control unit 210, and written to the low-resolution buffer 313a of the storing unit 313 under a control of the controller 301. The frame frequency of the low-resolution image data to be transmitted is 60 Hz or 30 Hz.

The low-resolution image data received by the image data receiver 300 is temporarily stored in the storing unit 313. The controller 301 detects or identifies that the display guidance information transmitter 311 has transmitted particular resolution information to the image data transmitter 200. Thus, the controller 301 can apply an instruction to the received image data decoder 312 to perform image decoding processing (processing for decoding the received low-resolution image data to high-resolution image data). The received image data decoder 312 decodes the low-resolution image data, buffered in the low-resolution buffer 313a of the storing unit 313, to form high-resolution image data suitable for the display 400, and stores the resultant data in the high-resolution buffer 313b of the storing unit 313.

The decoded high-resolution image data is output at a frame frequency of 60 Hz to the high-resolution display 400 via the output unit 314. In the display 400, the image data is received via a driver, and the driver supplies the image data to a display element.

If the display 400 is not a high-resolution display but a low-resolution display corresponding to resolution within the data-transmission capacity of the one dual-link DVI cable 100, the particular display guidance information does not transmit to the image data transmitter 200 side from the display guidance information transmitter 311, then there is no need of sending particular display guidance information since the image data transmitter 200 is also set to conform to low resolution. In this case, the low-resolution image data transmitted from the image data transmitter 200 via the one dual-link DVI cable 100 is directly stored in the storing unit 313 without the low-resolution image data being converted into a high-resolution image data, and the low-resolution image data is directly used.

The above method describes that individual controls are performed according to existence or not of the particular display guidance information, but a method opposite to the above method may be employed. Namely, if the display 400 conforms to low resolution, information corresponding to a compression ratio of 1 may dare to be transmitted as particular display guidance information. If there is no particular display guidance information, the image data transmitter 200 supposes that the display 400 conforms to high resolution, and the image data transmitter 200 automatically sets the compression ratio to ½, whereby image data corresponding to high resolution is transmitted.

In case the above mentioned method is employed and the particular display guidance information is transmitted to the image data transmitter 200, low-resolution image data read from the low-resolution buffer 213a of the storing unit 213 in the image data transmitter 200, is written into the low-resolution buffer 313a of the storing unit 313 in the image data receiver 300, then this low-resolution image data is transmitted to the display 400 as it is, without image decoding.

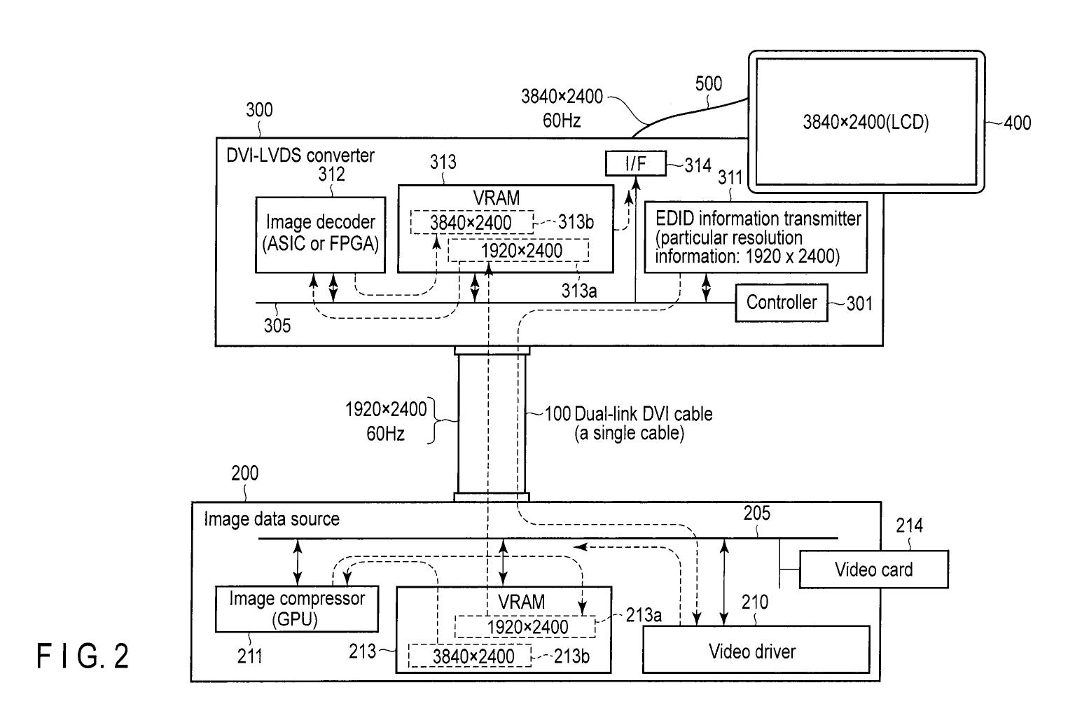

FIG. 2 shows a more specific embodiment. Reference number 200 denotes an image data source, such as a personal computer. The image data source 200 comprises a video driver 210, an image compressor 211, and a video RAM (VRAM) 213 as a memory, and a main bus 205 connected to these elements.

The image data source 200 is connected to a DVI-LVDS converter 300 via one dual-link DVI cable 100. The DVI-LVDS converter 300 comprises a controller 301, an extended display identification data (EDID) information transmitter 311, an image decoder 312, a storing unit (VRAM) 313 as a memory, an output unit 314 serving as an interface and connected to the display 400 via the LVDS cable 500, which are respectively connected to a main bus 305. The EDID can be treated as data indicating the display capacity of the display. The image decoder 312 is formed of, for example, an application specific integrated circuit (ASIC) or a field programmable gate array (FPGA).

The display 400 has a liquid crystal display panel and is a high-resolution display with 3840×2400 pixels (so-called 4K2K).

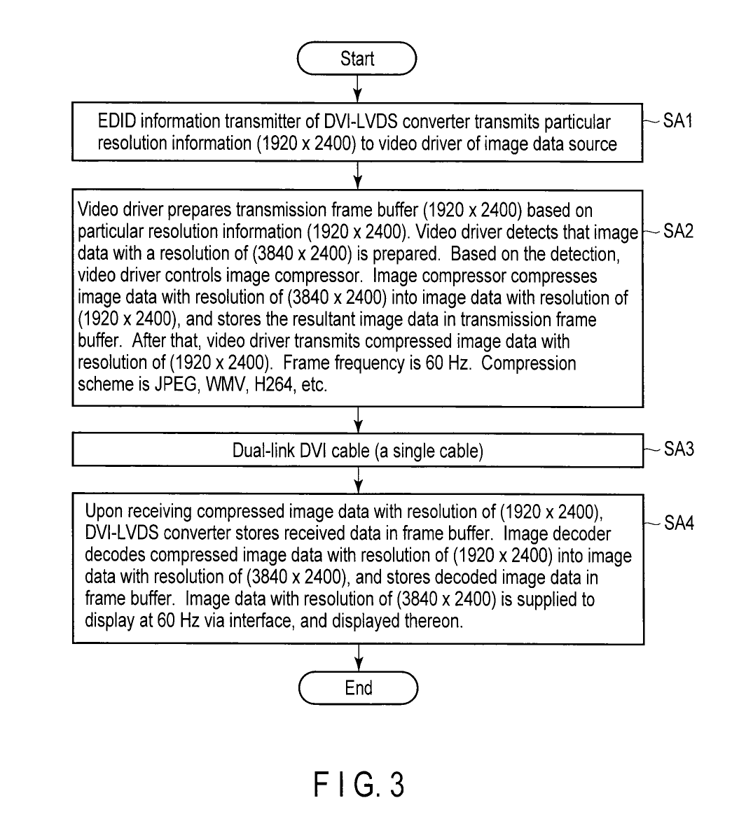

FIG. 3 is a flowchart useful in explaining the operation of the embodiment shown in FIG. 2. Firstly, the EDID information transmitter 311 of the DVI-LVDS converter 300 supplies the video driver 210 of the image data source 200 with particular display guidance information (resolution information) including resolution information (indicating, for example, a resolution of 1920×2400 pixels), although the display 400 is a high-resolution display that can deal with a resolution of 3800×2400 pixels (SA1). The resolution information in the particular display guidance information is included in display guidance information (or profile) shown in FIG. 1. The display guidance information may include information designating a frame frequency.

In accordance with the resolution information in the particular display guidance information, the video driver 210 prepares a frame buffer (having a capacity of 1920×2400 pixels) 213a in the VRAM 213.

Since the video driver 210 beforehand writes image data in the high-resolution buffer 213b of the VRAM 213, supposing that the resolution of the image data as source data from the video card 214 is 3840×2400 pixels, it controls the image compressor 211 based on particular display guidance information, to cause the compressor 211 to compress, into image data with a resolution of 1920×2400 pixels under the control of the video driver 210, the image data with a resolution of 3840×2400 pixels beforehand stored in the high-resolution buffer 213b. The image compressor 211 sets the compressed image data with the resolution of 1920×2400 pixels as transmission data in the low-resolution buffer 213a of the VRAM 213. The image data with the resolution of 1920×2400 pixels set in the low-resolution buffer 213a of the VRAM 213 is transmitted to the DVI-LVDS converter 300 via the one dual-link DVI cable 100 under the control of the video driver 210. The frame frequency of the compressed image data to be transmitted is 60 Hz (SA2, SA3).

Compression schemes for image data compression include Joint Photographic Experts Group (JPEG), Window (trademark) Media Video (WMV), H264, etc.

The low-resolution image data with the resolution of 1920×2400 pixels received by the DVI-LVDS converter 300 is buffered in the low-resolution buffer 313a of the VRAM 313. The controller 301 of the DVI-LVDS converter 300 detects that the EDID information transmitter 311 has transmitted the resolution information included in the particular display guidance information. Accordingly, the controller 301 provides the image decoder 312 with an instruction to perform image decoding. The image decoder 312 decodes, into high-resolution image data with the resolution of 3840×2400, the low-resolution image data with the resolution of 1920×2400 pixels buffered in the low-resolution buffer 313a of the VRAM 313, and stores the resultant image data in the (output) high-resolution buffer 313b of the VRAM 313. The decoded high-resolution image data with the resolution of 3840×2400 is output at a frame frequency of 60 Hz to the high-resolution display 400 via the output unit 314 and the LVDS cable 500 (SA4). In the display 400, the image data is received via a driver, and the driver supplies the image data to a display element.

In the figures showing the embodiment and the basic structure thereof, the high-resolution display 400 and the DVI-LVDS converter 300 are components independent of each other. However, in the practical product level, a substrate provided with the DVI-LVDS converter 300 may be contained in the cabinet of the high-resolution display 400. Alternatively, a separate box containing the DVI-LVDS converter 300 may be prepared independently of the cabinet of the high-resolution display 400. Further, the image decoder 312 may be contained in the cabinet of the high-resolution display 400. Yet alternatively, the image decoder 312 and part (the high-resolution buffer 313b for buffering image data with the resolution of 3840×2400) of the VRAM 313 may be contained in the cabinet of the high-resolution display 400.

The image data source 200 may also be referred to as a personal computer, a server, an image data transmitter, image data transmission means, a signal source or a block. Similarly, the image compressor 211 may also be referred to as a graphics processor, an image converter, an image encoder or a block. The DVI-LVDS converter 300 may also be referred to as a receiver, an image converter, an image decoder, an image processor or a block.

In the above embodiment, when the EDID information transmitter 311 transmits the resolution information of the high-resolution display to the video driver 210, particular display guidance information (resolution information) that does not indicate a high resolution is transmitted. However, various types of information are possible as the resolution information. The resolution information may indicate that the resolution of the high-resolution display is 1920×2400 pixels. Further, although in the embodiment, high-resolution image data has the resolution of 3840×2400 pixels, the high resolution is not limited to this, but may be a resolution of 4000 (horizontal pixels)×2000 (vertical pixels) pixels, i.e., a so-called 4K resolution. Further, image data with a resolution of from 3200×2160 to 4096×2160 pixels may be employed.

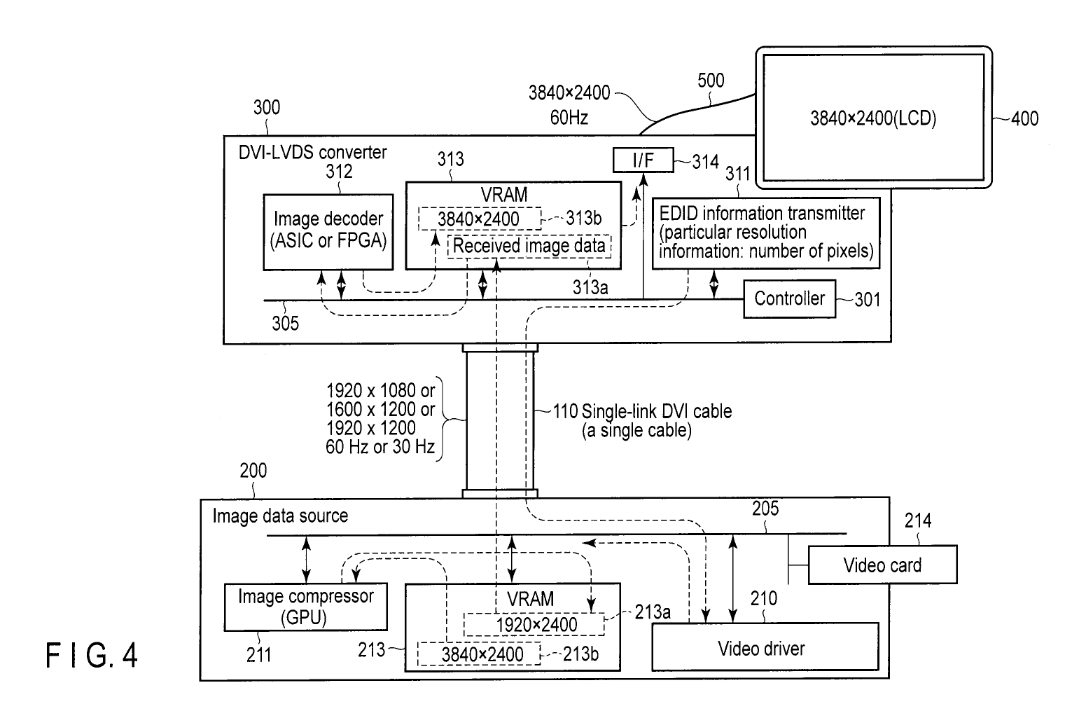

FIG. 4 shows another embodiment. In the first-mentioned embodiment, the image data source 200 is connected to the DVI-LVDS converter 300 via the dual-link DVI cable 100. However, in light of the above idea, the image data source 200 can be connected to the DVI-LVDS converter 300 via one single-link DVI cable 110.

Assume here that there is a demand for displaying image data in the image data source 200 on the display 400, and also that the resolution and/or the frame frequency of the image data in the image data source 200 exceeds the transmission capacity of the one single link DVI cable 110. Assume further that the display capacity of the display 400 is sufficient to display the image data in the image data source 200.

In this case, when the EDID information transmitter 311 transmits the resolution information of the high-resolution display 400 to the video driver 210, it transmits particular display guidance information including resolution information that does not indicate a high resolution. Assume here that the resolution information has a data amount that can be transmitted by the one single-link DVI cable 110. The resolution information indicates a resolution of 1920×1080, 1600×1200, 1920×1200 etc. Further, the particular display guidance information may simultaneously include a frame frequency of 60 Hz or 30 Hz.

The image data source 200 performs image conversion corresponding to the particular display guidance information (resolution information), and transmits the resultant image data to the DVI-LVDS converter 300. The DVI-LVDS converter 300 restores the image data from the image data source 200 to image data of a true resolution, and supplies the resultant image data to the display 400. In this embodiment, it is a matter of course that the one dual-link DVI cable 100 may be employed.

Further, although in the above-described embodiments, the image data transmitter (or image data source) 200 as the first block and the image data receiver (or DVI-LVDS converter) 300 as the second block are connected by the one DVI cable 100 or 110, they can also be connected by one HDMI cable in light of the concept of this embodiment.

The technical terms used above in relation to the embodiments and the names or technical terms used in the drawings are in no way restrictive. For example, the processor may be replaced with processing unit, a processing block, or a processing module. Likewise, the controller may be replaced with control means, a control unit, a block or a control module. The same can be said of the image data transmitter, the transmission image data generator, the storing unit, the display guidance information reception/control unit, the display guidance information transmitter, or he received image data decoder. Furthermore, in a claim, even if each element is divided into components and the components are claimed, or even if a combination of components is claimed, the claimed elements do not depart from the present invention. Also, even if a claim is directed to a method, it is considered that the apparatus of the invention is applied to the method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic display device including a second block that is permitted to be connected via one interface cable to a first block serving as a signal source, and supplies a display with image data having a resolution suitable for a display capacity of the display, comprising:
an information transmitter provided in the second block and configured to transmit, to the first block, particular display guidance information being set by specification information including resolution information of the display and specification information of the one interface cable;
an information reception unit provided in the first block and configured to receive the particular display guidance information, and to process image data adapted to the specification of the one interface cable to transmit to the first block;
an image decoder provided in the second block and configured to decode first image data from the first block into second image data with the resolution suitable for the display capacity of the display, the first image data being processed in the first block based on the particular display guidance information such that the first image data conforms to a transmission format of the one interface cable; and
an output unit configured to output the decoded image data of the resolution to the display via the one interface cable.

2. The electronic display device of claim 1, wherein the particular display guide information is set to resolution information indicating difference resolution from the resolution of the display, when the resolution of the display is larger than that of one interface cable.

3. The electronic display device of claim 1, wherein the one interface cable is a single-link or dual-link DVI cable, and the display is a high-resolution display configured to display image data having a resolution higher than a transmission capacity of the interface cable.

4. The electronic display device of claim 1, wherein the first image data processed in the first block based on the particular display guidance information and sent from the first block is obtained by compressing image data of a high resolution into image data of a low resolution.

5. The electronic display device of claim 1, wherein the particular display guidance information also includes frame frequency information designating a frame frequency of the first image data sent from the first block.

6. A control method for use in an electronic display device including a second block that is permitted to be connected via one digital video interface (DVI) cable to a first block serving as a signal source, and supplies a display with image data having a resolution suitable for a display capacity of the display, comprising:
transmitting, from the second block to the first block, particular display guidance information being set by specification information including resolution information of the display and specification information of the one interface cable;
decoding first image data from the first block into second image data with the resolution suitable for the display capacity of the display; and
outputting the decoded image data of the resolution processed at the second block to the display.
